(19) United States
(12) Patent Application Publication
(10) Pub. No.: US 2005/0260468 A1
(43) Pub. Date: Nov. 24, 2005

(54) Fuel handling techniques for a fuel consuming generator

(75) Inventors: Michael L. Fripp, Carrollton, TX (US); David Stickler, Billerica, MA (US); Haoyue Zhang, Carrollton, TX (US); Ian Robb, Carrollton, TX (US); Jamie Woodroffe, Billerica, MA (US)

Correspondence Address: CONLEY ROSE, P.C., P. O. BOX 3267, HOUSTON, TX, 77253-3267, US

(73) Assignee: Halliburton Energy Services, Inc., Houston, TX (US)

(21) Appl. No.: 10/849,758

(22) Filed: May 20, 2004

(51) Int. Cl. H01M 8/06; F02B 45/00

(52) U.S. Cl. 429/19; 123/23; 123/24 R

(57) ABSTRACT

A self-contained power generator comprises a fuel source, a solid oxygen source capable of releasing oxygen when heated, an engine capable of generating power by combusting the fuel with the oxygen so as to produce exhaust gases, and an exhaust gas absorbent. The oxygen source and the exhaust gas absorbent are preferably combined. The oxygen source may comprise potassium superoxide in combination with sodium peroxide, potassium oxide, or calcium oxide The engine may be any known heat engine. Fuel is fed to the engine at a desired rate so as to generate power at a desired rate. Heat from said combustion is preferably applied to the oxygen source and heat may be exchanged between the exhaust gases and oxygen. The exhaust gases are preferably absorbed at substantially the same rate as the rate at which they are generated such that pressure in the generator does not increase.

### CROSS-REFERENCE TO RELATED APPLICATIONS

Not Applicable.

### STATEMENT REGARDING FEDERALLY SPONSORED RESEARCH OR DEVELOPMENT

Not Applicable.

### TECHNICAL FIELD OF THE INVENTION

The present invention relates generally to power generators and more particularly to power generators that are capable of operating in confined environments. In addition, the present invention relates to techniques for capturing exhaust gases generated by a power-generating chemical reaction.

### BACKGROUND OF THE INVENTION

There are various environments in which it may be desirable to provide a power generator that is capable of operating in a self-contained manner. For a power generator based on a heat engine, this entails containment of a fuel, an oxidizer, the engine itself, and any exhaust gases that are produced by the engine.

One example of a context in which such a self-contained power generator would be desirable is for downhole power generation. Certain drilling operations that are carried out downhole require significant power. Typically, the amount of power required is too great to be practically supplied by batteries. Similarly, it is not practical to transmit power from a source at the surface. Thus, current downhole power source use turbines or the like to extract power from the flow of pressurized drilling mud that circulates in the hole. These are most useful, however, for generating low power levels over long periods of time. For certain downhole operations, such as wireline logging, tubing-conveyed logging, measuring while drilling, logging while drilling, permanent completions, subsea applications, mining, space-based drilling, and autonomous robots, larger amounts of power are needed than can be obtained from the mud.

In order to generate greater amounts of power in the absence of other energy sources, it is typically necessary to combust a fuel. Combustion requires an oxidizer that will react with the fuel. A typical oxidizer is oxygen gas. In addition, if the engine is going to be used in a contained environment, it is necessary to contain the exhaust gases, so it is necessary to provide a method for storing the exhaust. Compressing the exhaust gas in order to vent it into the circulating mud requires too much energy, because of the high hydrostatic pressure downhole (on the order of 15,000 psi). Thus, it is more energy efficient to capture the gas than to expend the effort to pump it into the circulating mud. In addition, if exhaust gases were not captured downhole and were allowed to enter the circulating mud, the balance of fluid pressures between the well and the formation might be disrupted, with potentially disastrous results.

Hence, power generation in a sealed environment using oxygen based combustion of a hydrocarbon as the energy source requires both availability of fuel and oxygen, and disposal of combustion products within the closed environment. Consequently, for many applications it is desirable to maximize the volumetric chemical energy storage density. It is also important to minimize the complexity of the power system, so as to enhance operational reliability.

Several patents discuss using a fuel-consuming generator for downhole power generation. However, these references focus on pressurized oxygen and pressurized hydrogen, which is neither safe nor efficient. For example, WO 01/40620 A1 discloses a downhole electric power generator. This reference discloses using oxygen gas in order to power a miniature internal combustion engine. U.S. Pat. No. 5,202,194 discloses a downhole power generator consisting of a fuel cell that is supplied by compressed hydrogen and compressed oxygen. US 2002/0034668 A1 discloses a fuel cell for downhole power systems and discloses using a pressurized gaseous oxidant to power the fuel cell.

Similarly, previous references typically do not discuss methods for dealing with exhaust gases because their preferred fuel has been hydrogen, which only leaves water as the exhaust product.

### SUMMARY OF THE INVENTION

The present invention provides a safe, efficient, and self-contained power source. The present power sources avoid the need to use oxygen gas as an oxidizer and do not require venting of exhaust gas. The present power source is capable of providing a relatively large amount of power. The power generated by the present invention may include mechanical power, electrical power, and/or heat.

In one embodiment, the present invention provides safer and more efficient methods for conveying an oxidizer in a self-contained power source. In addition, this disclosure discusses the use of chemical decomposition for the safe and efficient production of oxygen that can be used in the power generation. In another embodiment, the present invention includes the use of chemical absorbents to collect the exhaust and to convert the exhaust to a volumetrically efficient solid phase.

Preferred means for storing oxygen in a safe non-gaseous state include compounds of the general class represented by potassium perchlorate. The oxygen-releasing compound may be stored in a solid or liquid state. Exemplary exhaust sorbents are represented by potassium hydroxide and calcium oxide. The oxidizer and the exhaust sorbent may be stored separately, or combined in part to optimize stored energy density, by matching the volume expansion of the sorbent to the volume decrease of the oxidiser upon reaction.

In one preferred embodiment, the present generator is a closed loop comprising a heat engine and a combined exhaust capture/oxygen production unit. Fuel is stored separately and preferably enters the loop via a controller. The heat engine is preferably an Otto cycle engine and electrical power is generated as the power output of the engine. Other heat engine cycles can be used as described in detail below. In certain other embodiments, the fuel and oxidizer can be used to simply provide extra heat, as might be needed for setting a tool, removing condensate, et cetera.

In certain other embodiments, the invention comprises a generator comprising a fuel source, an oxygen-based compound capable of releasing oxygen, an engine capable of generating power by reacting the fuel with the oxygen, the reaction producing an exhaust product, and an exhaust product absorbent. The oxygen-based compound and the exhaust product absorbent may be the same material, the oxygen-based compound may release oxygen when heated, and/or the oxygen source may comprise potassium superoxide (KO₂) and a second reagent selected from the group consisting of sodium peroxide (Na₂O₂), potassium oxide (K₂O), calcium oxide (CaO), and combinations thereof. The engine may be an internal or external combustion engine and fuel may be fed to the engine at a desired rate so as to generate power at a desired rate.

Still further, in various embodiments, heat from the combustion is applied to the oxygen-based compound and may be exchanged between the exhaust gases and the oxygen. The exhaust gas absorbent may be capable of absorbing an exhaust gas at substantially the same rate as the rate at which the exhaust gas is generated such that pressure in the generator does not increase. The fuel source may comprises at least one hydrocarbon and may comprise an oilfield production fluid.

In still other embodiments, a power source for use in drilling, well completion or servicing operations is provided, comprising a fuel source, an oxygen-based compound capable of releasing oxygen, and an engine capable of generating power by reacting the fuel with the oxygen, wherein the engine is mechanically connected to an oilfield tubular. Alternatively, the engine may produce an exhaust product and the device may include an exhaust product absorbent positioned to absorb the exhaust product. The engine may be mechanically connected to an oilfield tubular.

In still other embodiments, the invention comprises a fuel cell, comprising an anode, a source of hydrogen in fluid contact with the anode, a cathode, an oxygen-based compound capable of releasing oxygen into contact with the cathode, a circuit electrically connecting the anode to the cathode, and, optionally, a proton exchange membrane separating the anode from the cathode and allowing the passage of protons from the anode to the cathode. The oxygen-based compound may be a solid or a liquid. The source of hydrogen may comprise methanol. The fuel cell may further comprise an exhaust gas absorbent positioned to absorb the CO₂ generated by oxidation of the methanol and the oxygen-based compound and the exhaust product absorbent may be the same material.

In alternative embodiments, the invention provides a method for generating power, comprising a) providing an engine, a fuel source, and oxygen from an oxygen source, b) reacting the fuel with the oxygen in an engine so as to generate power, wherein the reaction produces an exhaust product; and c) absorbing the exhaust product in an exhaust product absorbent. Steps b) and c) are carried out in a well or underwater and the oxygen source may comprise an oxygen-based compound that releases oxygen when heated, in which case step a) preferably includes heating the oxygen source. Heating may be accomplished by exchanging heat between the exhaust gases and at least one of the oxygen source and the fuel source. The engine may be an internal or external combustion engine.

The present self-contained power generators can be used to provide large amounts of power, on the order of hundreds of watts to several kW. The fuel consuming reaction is scalable and can be used to provide small amounts of power, without deviation from the essence of the invention. If the generator is used downhole, it can be used while drilling, on a service string, in a permanent completion, on a logging string, or on a robot. The generator can be used to provide electricity to directly power telemetry, sensors, and actuators or it can be used to charge batteries, capacitors, and other power storage devices. Alternatively, at least a portion of the power output of the present generator might not be converted to electrical power and might be used as direct mechanical output to actuate devices, such as moving valves, pumping hydraulic fluids, or providing artificial lift.

Thus, the present invention comprises a combination of features and advantages which enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a schematic diagram showing the components of a self-contained generator constructed according to a first embodiment of the invention;

FIGS. 2-4 are schematic diagrams showing three embodiments of an exhaust capture/oxygen generation system suitable for use in a preferred embodiment of the present generators; and

FIG. 5 is a schematic diagram showing the components of a self-contained generator constructed according to an alternative embodiment of the invention.

### DETAILED DESCRIPTION OF THE PREFERRED EMBODIMENTS

System

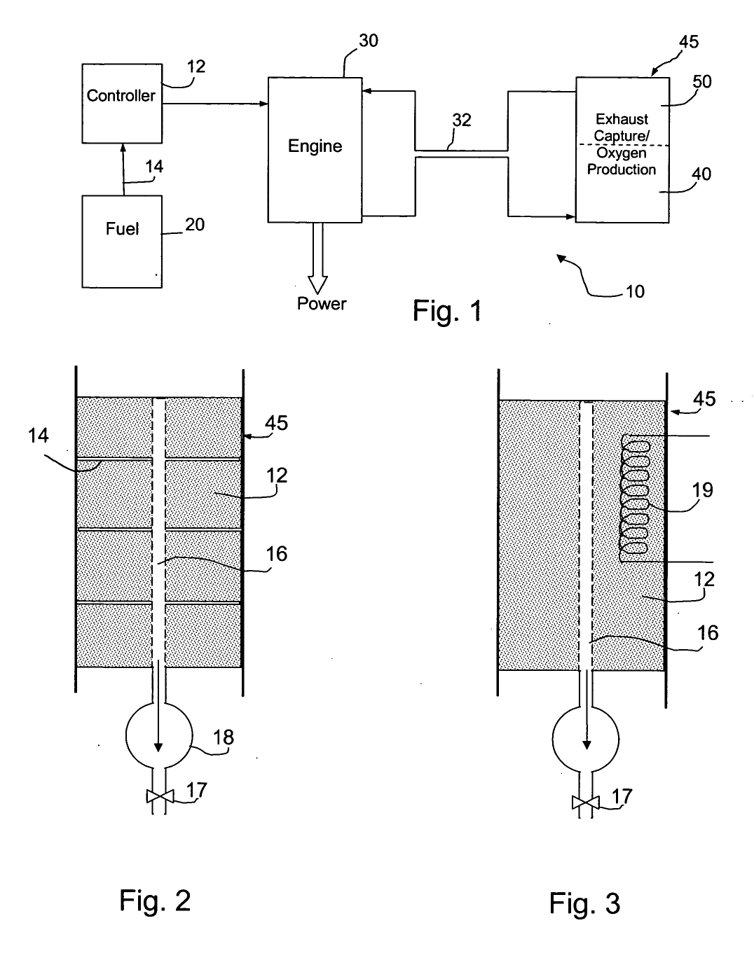

Referring initially to FIG. 1, one embodiment of a self-contained generator 10 constructed according to the present invention includes a fuel source 20, an engine 30, an oxygen source 40 and an exhaust gas absorbent 50. As discussed in detail below, oxygen source 40 and exhaust gas absorbent 50 are preferably combined in a single vessel 45. Fuel source 20 may be any fuel source such as are known in the art. These include, but are not limited to pressurized hydrocarbon gas and solid hydrocarbon or other fuel. The flow of fuel from fuel source 20 is preferably but not necessarily controlled by a controller 12 in the fuel line between fuel source 20 and engine 30. The fuel can also be a hydrocarbon that is being produced in the well.

Engine 30 is preferably a heat engine, and may be any suitable type of heat engine such as are known in the art, including but not limited to Otto cycle, diesel, Brayton cycle, Rankine cycle, or Stirling. In a preferred embodiment, engine 30 is an Otto cycle internal combustion engine. Thus, gases entering engine 30 preferably include a fuel and the oxygen needed for combustion of that fuel. In the embodiment shown in the Figure, gaseous fuel flows from fuel source 20 to engine 30 via line 14. A controller 12 preferably controls the rate of flow in line 14. Oxygen is provided to engine 30 via line 52. It is possible to blend the fuel in line 14 with the contents of line 52 upstream of engine 30, but this is not preferred because of the possibility of undesired combustion. The gaseous products that result from combustion of the fuel are passed to oxygen source 40 and exhaust gas absorbent 50. The gaseous products of reactions in those components are in turn recycled back to engine 30, as described further below.

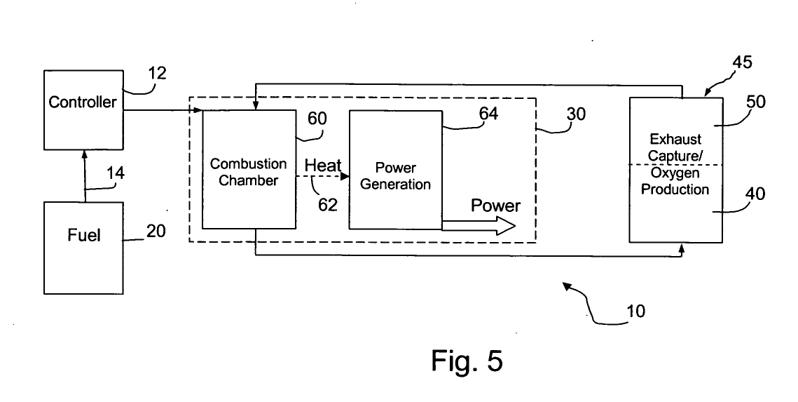

In embodiments in which other types of heat engine are used, combustion may take place outside of the engine. Referring briefly to FIG. 5, in these embodiments, engine 30 includes a combustion chamber 60. Heat from the chamber is transferred to a power generating component 64 using a suitable conventional heat transfer technology, as indicated by phantom arrow 62. As in the embodiments described above, exhaust gases from the combustion reaction are passed to exhaust capture/oxygen production vessel 45. Correspondingly, oxygen produced in oxygen source 40 is sent to the combustion chamber 60.

Oxygen Source and Exhaust Gas Absorbent

Various compositions can be used for the generation of oxygen and/or the absorption of exhaust gases. A particularly preferred objective is for all exhaust gases absorb to form stable condensed phase products. In a preferred embodiment, use of compounds of alkali (K, Na, etc.) or alkaline earth (Ca, Mg, etc.) metals with oxygen, at a high oxidation state, allows exhaust capture and oxygen production to be accomplished with a single material. Proper proportioning of various compounds allows matching of oxygen production to the oxygen content of the exhaust absorbed, thus directly achieving a closed loop species balance, without dependence on kinetically controlled processes.

In certain embodiments, oxygen source 40 comprises an oxygen-based compound. As used herein, “oxygen based compound” refers to a compound having two or more ingredients. In compounds suitable for use as an oxygen source in these embodiments, oxygen is bonded to another element such that the compound evolves oxygen in response to a chemical reaction, heat, or other stimulus. In other embodiments, oxygen source 40 may comprise air, oxygen, or another oxygen-containing gas.

The following Examples illustrate these principles but are not intended to limit the invention in any way.

### EXAMPLE 1

By way of illustration, when butane is used as the fuel, the combustion reaction proceeds according to the formula:
C₄H₁₀+6.5 O₂→4 CO₂+5 H₂O. (1)
This reaction can be followed by exhaust capture as solid species and oxygen production using a combination of potassium superoxide (KO₂) and sodium peroxide (Na₂O₂):
4 CO₂+5H₂O+4KO₂+7Na₂O₂→2K₂CO₃+2Na₂CO₃+10NaOH+6.5O₂ (2)

Reaction (1) produces gaseous combustion products and sensible enthalpy for operation of a heat engine. Reaction (2) captures those gaseous products as solids, and produces the oxygen flow required for further operation of the heat engine.

Another option for this class of operation includes the same combustion process with exhaust capture and oxygen production using a combination of potassium superoxide (KO₂) and potassium oxide (K₂O):
4 CO₂+5 H₂O+8.67 KO₂+4.67 K₂O→4 K₂CO₃+10 KOH+6.5 O₂ (3)

### EXAMPLE 2

Still another variation utilizes calcium oxide (CaO) and potassium superoxide (KO₂). It is preferable to contact these sorbents sequentially, with the exhaust first reacting with the calcium oxide to convert the water to calcium hydroxide (Ca(OH)₂) followed by carbon dioxide capture by potassium superoxide to produce the requisite oxygen. The simplest means of achieving a stoichiometric oxygen balance for this system is to use a fuel such as butene (C₄H₈), which requires 6 O₂ for stoichiometric combustion, according to Equation (4):
C₄H₈+6 O₂→4 CO₂+4 H₂O (4)
Selective reaction of calcium oxide with water vapor produces calcium hydroxide and unreacted carbon dioxide:
4 CO₂+4 H₂O+4 CaO→4 CO₂+4 Ca(OH)₂ (5)
This can be followed by contacting the carbon dioxide with potassium superoxide, producing the requisite oxygen for overall balance:
4 CO₂+8 KO₂→4 K₂CO₃+6 O₂. (6)

### EXAMPLE 3

Yet another variation allows combustion of butane, for example, with sequential water and carbon dioxide absorption, together with oxygen production. The combustion reaction is:
C₄H₁₀+6.5 O₂→4 CO₂+5 H₂O (7)
The first absorption stage uses calcium peroxide as the sorbent for the water vapor, producing a net oxygen output:
4 CO₂+5 H₂O+5 CaO₂→4 CO₂+5 Ca(OH)₂+2.5 O₂ (8)
Subsequent reaction of the carbon dioxide/oxygen mixture uses a tailored sorbent combination to produce the net stoichiometric oxygen required for butane combustion:
4 CO₂+2.5 O₂+5.33 KO₂+2.67 KOH+1.33 CaO→4 K₂CO₃+1.33 Ca(OH)₂+6.5 O₂ (9)
The primary product of the reaction of calcium oxide with the combustion products is calcium hydroxide. Other products, such as calcium carbonate, are also formed, but their rates of formation much lower and their presence is not significant in the present systems.

As an alternative to calcium, metal salts could be used as the absorbent. The metal salts could be magnesium based, such as magnesium oxide, or they could be aluminum equivalents, such as aluminum sulfate. These salts, being more expensive than lime, are less appealing than using a lime bed.

A further list of possible fuels and the associated reactions is given below in Table 1. Table 1 is not an exhaustive list and is provided merely for exemplary purposes. In Table 1, the items listed above “Water (Drill Mud)” are suitable for use in internal combustion engines, while “Water (Drill Mud)” and the items below it are suitable for use in external combustion engines. Typically, the fuel is expected to be a hydrocarbon such as octane, heptane, nonane, decane, or diesel fuel. However, a wide range of fuels could be used. The preferred conversion technologies are based upon the energetic nature of the combustion and the controllability of the combustion.

TABLE 1

| | | Conversion | |
|---|---|---|---|
| Oxidiser | Fuel | Technology | Product Storage |
| Nitrous Oxide (G) | Octane | MICE | Absorb/Cond |
| Oxygen (G) | Octane | MICE | Absorb/Cond |
| Nitric Acid | Octane | MICE | Absorb/Cond |
| Potassium Chlorate | Octane | MICE | Absorb/CaO |
| Potassium Perchlorate | Octane | MICE | Absorb/CaO |
| Potassium Perchlorate | CS₂ | MICE | Absorb/CaO |
| Water (Drill Mud) | Potassium | Rankine Cycle | K₂/H₂ (exc) |
| Nitrous Oxide (G) | Boron | Rankine Cycle | Li₃N, B₂O₃ |
| Sulfur | Aluminum | Rankine Cycle | Al₂S₃ (Sep) |
| Nitrous Oxide (G) | Magnesium | Rankine Cycle | Li₃N, MgO |
| Bromine | Lithium | Rankine Cycle | LiBr (Sep) |
| Sulfur | Magnesium | Rankine Cycle | MgS (Sep) |
| Sulfur | Aluminum | Rankine Cycle | Al₂S₃ (Reac) |
| Bromine | Lithium | Rankine Cycle | LiBr (Reac) |
| Sulfur | Magnesium | Rankine Cycle | MgS (Reac) |
| Nitrogen Tetroxide (L) | Magnesium | Rankine Cycle | Li₃N, MgO |
| Nitrogen Tetroxide (L) | Boron | Rankine Cycle | Li₃N, B₂O₃ |
| Teflon | Magnesium | Rankine Cycle | MgF₂, C (Sep) |
| Sulfur Hexafluoride | Lithium | Rankine Cycle | Li₂S, LiF (Sep) |
| Potassium Perchlorate | Magnesium | Rankine Cycle | KCl, MgO (Sep) |
| Teflon | Magnesium | Rankine Cycle | MgF₂, C (Reac) |

The foregoing examples demonstrate that a wide range of fuels can be used in the present closed combustion systems, with the sorbent chemistry preferably tailored to produce the requisite oxygen output relative to exhaust absorbed to provide a net oxygen balance. In order to avoid the need for specialized additional sorbent stages, it is preferable to limit the selection of fuels to those containing only the elements C, H and O. There is an enormous range of such compounds, including but not limited to alkanes (e.g. butane), alkenes (e.g. butene), alkynes (e.g. butyne), alcohols (e.g. methanol), ketones (e.g. acetone), aldehydes (e.g. acetaldehyde), ethers (e.g. methyl ethyl ether), and a wide range of aromatic compounds (e.g. benzene, toluene) that may be chosen to provide physical or chemical properties as appropriate for the particular application. In a preferred embodiment, substantially all of the exhaust gases are absorbed and form stable condensed phase products. In certain other embodiments, 99, 95, 90 or 85% of the exhaust gases are absorbed and form stable condensed phase products, while the balance of the gases are either vented or stored.

The sorbent reaction processes are generally exothermic overall, which drives a temperature increase in the sorbent volume. Since some sorbents (e.g. CaO₂, which decomposes at ˜200° C.) and reaction products (e.g. Ca(OH)₂, which decomposes at ˜580° C.) are unstable at high temperatures, it is desirable to provide sufficient heat transfer from the sorbent volume to a heat sink (typically the working environment) to limit the local temperature rise to an acceptable level. In practice, most applications require a relatively long operating period, which in turn requires that the sorbent volume and container surface area must be sufficiently large relative to the sorbent heat release rate that conduction suffices to limit sorbent temperature rise. The temperature difference between the sorbent and the working environment can be converted into additional electrical energy through the use of thermoelectric devices or an additional heat engine.

It is important to note that in many cases the sorbent-product volume exceeds that of the unreacted sorbent, so that the initial sorbent loading must be limited to that which will allow the solvent to increase in volume as it reacts. There are various ways to achieve this result, including but not limited to the use of sorbent in a crushable form or with a crushable packing/filler that allows the density of the sorbent to be increased as needed. In practice this is not a substantive limitation, since it is difficult to achieve an initial granular or powder bed packing density high enough to exceed this constraint.

Referring again to FIG. 1, exhaust gases and unreacted feed gases leave engine 30 via line 34 and flow into exhaust capture/storage and oxygen production vessel 45. The gases react in vessel 45 to produce solid phase products, as described above, and a net oxygen output, which leaves vessel 45 via line 54. The gases in line 54 are oxygen-rich and may contain unreacted hydrocarbon gas, which is burned with the fuel gas in engine 30. It is sometimes preferable that the exhaust flow be partially cooled before reaching the sorbent volume in order to constrain sorbent peak temperature. In some embodiments, cooling is achieved by counterflow heat exchange with the oxygen flow, as indicated at numeral 32 in FIG. 1.

This approach provides substantial functional benefits. It is typically desirable to operate a heat engine with some degree of combustion product dilution, so as to limit temperature rise to a level compatible with the engine structure. Conventionally, this is achieved by using air as the oxygen source, and providing a cooling means for the hot components of the engine. In the present system, if dilution is desired, it can be achieved either by adding an inert gas (e.g. argon or nitrogen) to the recirculating flow, or by circulating an excess of oxygen. In the latter case, the engine always operates lean, with power output controlled solely by the fuel delivery rate. This has the direct benefit that the flow time lags inherent in transporting exhaust to and into the sorbent volume, and oxygen to the engine intake are irrelevant to engine throttle control: a rapid change in fuel delivery rate simply causes consumption of a higher fraction of the oxygen in the intake flow, with oxygen flow rate responding to demand typically within a time period on the order of one second (depending on flow loop void volume and gas flow rate).

As can be seen in the foregoing Examples, oxygen source 40 and exhaust gas absorbent 50 may be provided as a single compound or composition, such that absorption of exhaust gases and production of oxygen occur concurrently and within a single vessel. In alternative embodiments, the oxygen source and exhaust capture may be separate. The oxygen source may be liquid or solid, but it is preferred that the exhaust capture medium be a solid, and more particularly a porous solid. For example, such a system might comprise potassium perchlorate as the oxygen source and calcium oxide/potassium hydroxide as the exhaust capture medium. In these systems, any unreacted oxygen is preferably absorbed with a secondary reactant dispersed in a lime bed. The reactant might be iron powder, elemental calcium, copper, magnesium, nickel (Raney Nickel). or the like. The oxygen absorbent may be interspersed within the lime bed or placed at the end of the lime bed (in series or in parallel). Potassium hydroxide can be used either in conjunction with the lime or instead of the lime.

A further benefit accrues in handling products of incomplete combustion in the present heat engine, or unreacted species that bypass the combustion process. The latter can occur in a two cycle engine due to partial loss of the intake charge to the exhaust flow in the scavenging process, or via flow leakage, for example around the piston rod seal in an ARI free piston linear engine. In the present system, such products as CO, H₂, and unburned hydrocarbons recirculate through the sorbent bed, and exit as trace species in the oxygen flow, with the result that they are subject to further oxidation in the engine. The result is that the exhaust gas/oxygen flow loop will reach a stable composition containing small concentrations of such species, as defined by the completeness of combustion achieved in the heat engine. This eliminates the need for exhaust catalytic conversion, for example, which could be required in a system where exhaust capture was separate from oxygen production.

It is recognized that final oxidation of such species could also occur in the flow transport lines or in the sorbent bed itself. For an acceptably efficient heat engine, this would represent only a small fraction of the overall system heat release, and have minor impact on thermal efficiency.

As disclosed above, the preferred method for providing oxygen to the generator is based on decomposition of an oxidizer. One technique uses the chemical found in oxygen candles that are featured in airplanes, space craft, and submarines. Oxygen candles store oxygen in a solid oxidant, such as potassium perchlorate, potassium chlorate, sodium chlorate, and/or sodium perchlorate. When heated, the solid oxidant decomposes, releasing oxygen. For example, sodium perchlorate decomposes into sodium chloride and oxygen. The oxygen can also be stored in a liquid oxidant, such as nitrous oxide, nitric oxide, nitric acid, or perchloric acid.

There are three common approaches for heating the oxidant above the temperature at which it will release its oxygen: 1) exothermic chemical reaction, 2) electrical heating, and 3) circulation of generator exhaust. Regardless of how the oxidant is heated, the solid phase oxidant behaves similarly to the preferred solid oxidant, potassium perchlorate. Namely, when heated, the following chemical reaction occurs:
KClO₄(solid)→KCl(solid)+2O₂(gas). (10)

The solid KCl remains in the oxidizer vessel and the oxygen gas exits the vessel and can be used in a combustion reaction in engine 30.

Exothermal Chemical Reaction

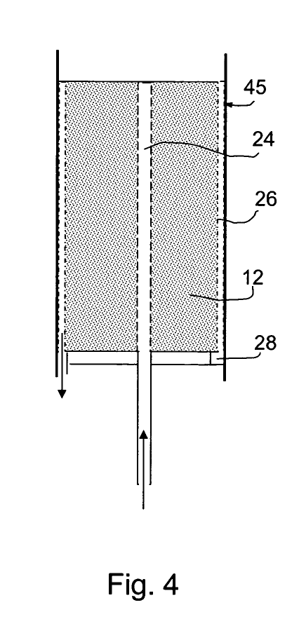

In this technique, illustrated in FIG. 2, relatively small amounts of an exothermal chemical are combined with the oxidizer to form a bed 12. The exothermal chemical may be rocket fuel, magnesium, lithium, potassium, aluminum, or any other suitable chemical. Ignition of the chemical in the presence of oxygen causes an exothermic reaction that warms the oxidant, causing it to release additional oxygen, some of which may be used to further the exothermal chemical reaction. This is the technique used in oxygen candles.

Typically the exothermal chemical and the oxidant are combined to form a waxy mixture. This mixture may be a solid mass or it may be segmented between insulating baffles 14 to allow controlled and/or intermittent operation. The released oxygen preferably flows out through a central passage 16 in bed 12 and passes through a pressure vessel or inflatable balloon 18, which regulates the output from the oxygen generator. There is preferably a pressure regulator or valve 17 at the exit of the pressure vessel to control the flow of oxygen. The rate of oxygen generation depends in part on the proportion of fuel that is combined with the solid oxidant, but it is expected that the ratio will be approximately 1 part fuel for every 4 parts of solid oxidant. The exothermal chemical reaction can be triggered by any of the electrical heating techniques mentioned in the next section.

Electrical Heating

Most of the preferred oxygen sources release oxygen when heated, typically above about 600° C. Hence, the desired oxygen flow can be obtained by heating the solid oxygen source sufficiently to cause oxygen to be released at the desired rate. An exemplary system, in which a resistance heater 19 is embedded in bed 12 is shown in FIG. 3. It will be understood that heater 19 can be configured in any desired configuration, including coiled around central passage 16 at a radius intermediate between passage 16 and the wall of vessel 45. Alternatively, heat can be provided by any other known means, including but not limited to thermoelectric elements, thermionic heaters, or heat pumps. Heat pumps, such as the thermoelectric module, have the advantage that they make another part of the engine cooler while simultaneously heating the oxidant. The result is that less energy is needed to decompose the oxidant and the efficiency of the cooled engine is increased. These electrical heating elements can be powered by the electrical output from the power generator itself or they can be powered by batteries.

Waste Heat

It is expected that in some embodiments, the present power generator will create waste heat because it will not operate at 100% efficiency. This waste heat can be applied to the solid oxygen source, causing the release of oxygen. In some embodiments, the waste heat is conducted to the oxidant by placing the generator in proximity to the oxidant. In other, more preferred embodiments, the waste heat is convected to the oxygen source in the exhaust from the generator. As illustrated in FIG. 4, the exhaust gas from a combustion generator passes through and into the bed of oxidant, preferably via a perforated line 24. The hot exhaust causes the oxidant to release oxygen. A pressure differential is maintained across the radius of bed 12 such that generated oxygen flows radially outward, through a perforated inner wall 26 and into an annular collection chamber 28. From chamber 28 the oxygen or oxygen diluted with exhaust flows to engine 30. An advantage of using the exhaust to heat the oxygen source is that the resulting oxygen is diluted with the exhaust gas. An overly rich oxygen mixture could damage a combustion engine by leading to a very high combustion and exhaust temperatures.

Regardless of which technique is selected, an operational constraint will be to ensure that there is an adequate local temperature rise to decompose the oxidizer at an acceptable rate, thus producing the oxygen needed to maintain the desired level of power generation.

Use in Fuel Cells

In one alternative embodiment, the systems described herein can be used in a fuel cell. In a standard Proton Exchange Membrane Fuel Cell (PEMFC) an anode is used in conjunction with a source of hydrogen that is in fluid contact with the anode to generate a flow of electrons to a cathode, producing electrical current. The protons disassociated from the electrons flow through a proton exchange membrane (PEM) directly to the cathode, where they recombine with the electrons and oxygen to give water. In a preferred embodiment, an oxygen-based compound that is capable of releasing oxygen into contact with said cathode is used as the source of oxygen. The oxygen-releasing compound may release oxygen when heated, and may also be capable of absorbing the produced water. It will be understood that other forms of fuel cells can be used, including phosphoric acid fuel cells, alkaline fuel cells, solid oxide fuel cells, and molten carbonate fuel cells.

### EXAMPLE 4

By way of illustration, when hydrogen and oxygen are used as the anode reactant and cathode reactant, the fuel cell reaction proceeds according to the formula:
6H₂+3 O₂→6 H₂O (11)
The oxygen production and the exhaust water capture can be accomplished in a manner similar to that articulated in examples 1 through 3. Specifically, the exhaust can be captured as a solid species and oxygen production using sodium peroxide (Na₂O₂):
6 H₂O+6 Na₂O₂→12 NaOH+3 O₂. (12)
Another option for this class of operation includes the same fuel cell reaction process with exhaust capture and oxygen production using a combination of potassium superoxide (KO₂) and potassium oxide (K₂O):
6 H₂O+4 KO₂+4 K₂O→12 KOH+3 O₂. (13)
The fuel cell reaction can also proceed with the exhaust water absorption in calcium oxide, shown in equation (4), or with the exhaust water absorption in calcium peroxide, as shown in equation (8).
Storage in Fullerenes

If desired, oxygen can be reversibly stored in a bed of fullerenes or carbon nanotubes. The concept of storing hydrogen gas in a bed of fullerenes has been demonstrated (“Feasibility of Fullerene Hydride as a High Capacity Hydrogen Storage Material,” by R. O. Loutfy and E. M. Wexler, Proceedings of the 2001 DOE Hydrogen Program Review, NREL/CP-570-30535, which is incorporated herein by reference. It is believed that oxygen can be stored in the fullerenes in the same manner than hydrogen is stored, namely via an oxygenation of carbon-carbon double bonds. Catalysts of precious metals, such as Pd, Pt, Ti, Zr, V, Nb, or Ta ions, or catalysts of alkali metals, such as Na, K, or Li, could be added to the fullerene to tailor the temperature and pressure needed to absorb and to release the oxygen. Note that a gaseous fuel, such as hydrogen, could also be stored in a bed of fullerenes. Oxygen can be released from the fullerenes by changing the partial pressure over the fullerene, by heating the fullerene, or by burning the fullerene.

Still another embodiment entails the use of a bed of carbon nanotubes to absorb the exhaust. It has been shown that nanotubes tend to wick gases into themselves. The gases are held in the cavity within each nanotube. While nanotubes are currently prohibitively expensive, future manufacturing techniques is expected to greatly reduce their price.

As mentioned above, the absorbent is preferably a finely ground powder. One variation involves dispersing the absorbent in water to form a slurry. In some cases, dispersing the absorbent in water may allow for quicker reaction between the exhaust and the absorbent. Alternatively, in order to accelerate the absorption of the exhaust, finely ground “seeds” of the final reactant may be dispersed within the absorbent. For example, calcium carbonate could be dispersed within the lime bed. These seeds have the potential to significantly increase the kinetics of the precipitation by providing nucleation sites upon which the reacted exhaust may build.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

1. A generator, comprising:
a fuel source;
an oxygen-based compound capable of releasing oxygen;
an engine capable of generating power by reacting said fuel with said oxygen, said reaction producing an exhaust product; and
an exhaust product absorbent.

2. The generator in accordance with claim 1 wherein said oxygen-based compound and said exhaust product absorbent are the same material.

3. The generator according to claim 1 wherein the oxygen-based compound releases oxygen when heated.

4. The generator according to claim 1 wherein said oxygen source comprises potassium superoxide (KO₂) and a second reagent selected from the group consisting of sodium peroxide (Na₂O₂), potassium oxide (K₂O), calcium oxide (CaO), and combinations thereof.

5. The generator according to claim 1 wherein said engine is an internal combustion engine.

6. The generator according to claim 1 wherein said engine is an external combustion engine.

7. The generator according to claim 1 wherein said fuel is fed to said engine at a desired rate so as to generate power at a desired rate.

8. The generator according to claim 1 wherein heat from said combustion is applied to said oxygen-based compound.

9. The generator according to claim 1 wherein heat is exchanged between said exhaust gases and said oxygen.

10. The generator according to claim 1 wherein said exhaust gas absorbent is capable of absorbing an exhaust gas at substantially the same rate as the rate at which said exhaust gas is generated such that pressure in the generator does not increase.

11. The generator according to claim 1 wherein the fuel source comprises at least one hydrocarbon.

12. The generator according to claim 11 wherein the fuel source comprises an oilfield production fluid.

13. A power source for use in drilling, well completion or servicing operations, comprising:
a fuel source;
an oxygen-based compound capable of releasing oxygen; and
an engine capable of generating power by reacting said fuel with said oxygen;
wherein said engine is mechanically connected to an oilfield tubular.

14. A power source for use in drilling, well completion or servicing operations, comprising:
a fuel source;
an oxygen source;
an engine capable of generating power by reacting said fuel with said oxygen, said reaction producing an exhaust product; and
an exhaust product absorbent positioned to absorb said exhaust product;
wherein said engine is mechanically connected to an oilfield tubular.

15. A fuel cell, comprising:
an anode;
a source of hydrogen in fluid contact with said anode;
a cathode;
an oxygen-based compound capable of releasing oxygen into contact with said cathode; and
a circuit electrically connecting said anode to said cathode.

16. The fuel cell according to claim 15, further including a proton exchange membrane separating said anode from said cathode and allowing the passage of protons from said anode to said cathode.

17. The fuel cell according to claim 15 wherein said oxygen-based compound is a solid or a liquid.

18. The fuel cell according to claim 15 wherein the source of hydrogen comprises methanol.

19. The fuel cell according to claim 15, further comprising an exhaust gas absorbent positioned to absorb CO₂ generated by oxidation of said methanol.

20. The fuel cell according to claim 19 wherein said oxygen-based compound and said exhaust product absorbent are the same material.

21. A method for generating power;
a) providing an engine, a fuel source, and oxygen from an oxygen source;
b) reacting said fuel with said oxygen in an engine so as to generate power, wherein said reaction produces an exhaust product; and
c) absorbing said exhaust product in an exhaust product absorbent.

22. The method of claim 21 wherein steps b) and c) are carried out in a well.

23. The method of claim 21 wherein steps b) and c) are carried out underwater.

24. The method according to claim 21 wherein the oxygen source comprises an oxygen-based compound that releases oxygen when heated, wherein step a) includes heating the oxygen source.

25. The method of claim 24 wherein the oxygen source is heated by exchanging heat between the exhaust gases and at least one of said oxygen source and said fuel source.

26. The method according to claim 21 wherein said oxygen source and said exhaust gas absorbent are the same material.

27. The method according to claim 21 wherein said oxygen source comprises potassium superoxide (KO₂) and a second reagent selected from the group consisting of sodium peroxide (Na₂O₂), potassium oxide (K₂O), calcium oxide (CaO), and combinations thereof.

28. The method according to claim 21 wherein said engine is an internal combustion engine.

29. The method according to claim 21 wherein said engine is an external combustion engine.

30. The method of claim 21 wherein the exhaust gases are absorbed at substantially the same rate as the rate at which they are generated.
